(19) United States
(12) Patent Application Publication
(10) Pub. No.: US 2007/0217010 A1
(43) Pub. Date: Sep. 20, 2007

(54) Reducing Reflection

(76) Inventor: Barret Lippey, Belmont, MA (US)

Correspondence Address: FISH & RICHARDSON PC, P.O. BOX 1022, MINNEAPOLIS, MN, 55440-1022, US

(21) Appl. No.: 11/686,635

(22) Filed: Mar. 15, 2007

Related U.S. Application Data
(63) Continuation-in-part of application No. 11/378,510, filed on Mar. 17, 2006.

(51) Int. Cl. G02B 27/28

(52) U.S. Cl. 359/493

(57) ABSTRACT

A polarizing layer is positioned between a surface and a window. The polarizing layer has a polarizing axis that is positioned to reduce visibility of the image reflected from the window.

### REFERENCE TO RELATED APPLICATIONS

This application is a continuation-in-part and claims the benefit of priority under 35 USC 120 of U.S. application Ser. No. 11/378,510, filed Mar. 17, 2006. The disclosure of the prior application is considered part of and is incorporated by reference in the disclosure of this application.

### TECHNICAL FIELD

This description related to reducing reflection.

### BACKGROUND

Light from sources of information on the dashboards of automobiles can cast images on the windshield that are superimposed on the driver's or passenger's view through the windshield. Liquid crystal displays (LCDs) and other modern display devices used for information, navigation, and entertainment systems create lager sources of such reflected images than the basic displays of radios and other instruments used in the past. The increasing angle of windshields in modern, aerodynamic cars can result in more reflections from the dashboard into the driver's field of view.

Light may also reflect from design features on the dashboard and cast images on the windshield that are superimposed on the driver's or passenger's view through the windshield.

### SUMMARY

In general, in one aspect, an apparatus includes an object having a surface that is positioned proximate to a window such that an image of the surface is reflected from the window in at least some lighting environments, and a polarizing layer positioned between the surface and the window, the polarizing layer having a polarizing axis that is positioned to reduce visibility of the image reflected from the window.

Implementations may include one or more of the following features. The window is a vehicle windshield. An antireflection layer is included. The polarizing layer includes stretched and dyed plastic film. The polarizing layer includes a polarizing coating. The polarizing axis is substantially parallel to a viewing direction through the window. The surface has a primarily diffuse reflection. The surface has a primarily specular reflection. The object is a design feature on a dashboard. The object is a speaker bezel. The object is a design feature on a rear package shelf. The polarizing layer is affixed to the surface.

In general, in one aspect, a method includes decreasing a reflection of light from a surface, the light reflecting from a vehicle window, by placing a polarizing layer between the surface and the vehicle window, the polarizing layer being configured to absorb a polarization state of the light source.

Implementations may include one or more of the following features. The polarization state is substantially s-polarization for the reflection from the vehicle window. The method includes affixing the polarizing layer to the surface.

### DESCRIPTION

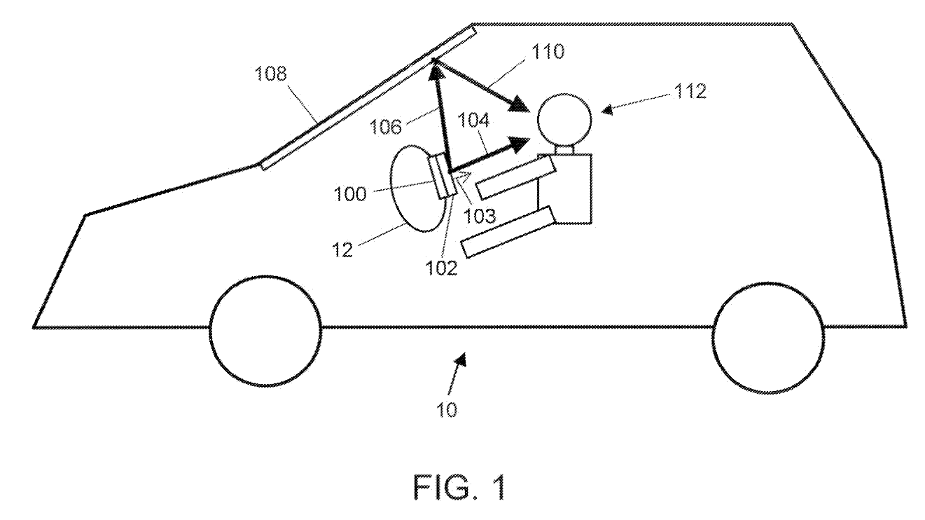

FIG. 1 is a schematic side view of a driver in a car.

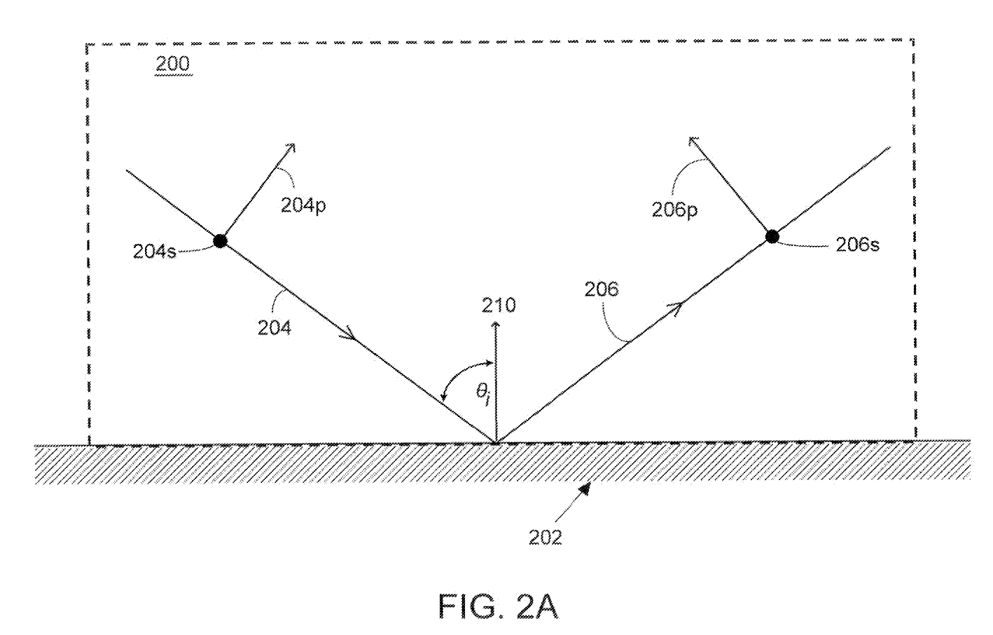

FIG. 2A is a diagram of reflection of light showing polarization components.

FIG. 2B is a graph of the reflectance of light as a function of incident angle.

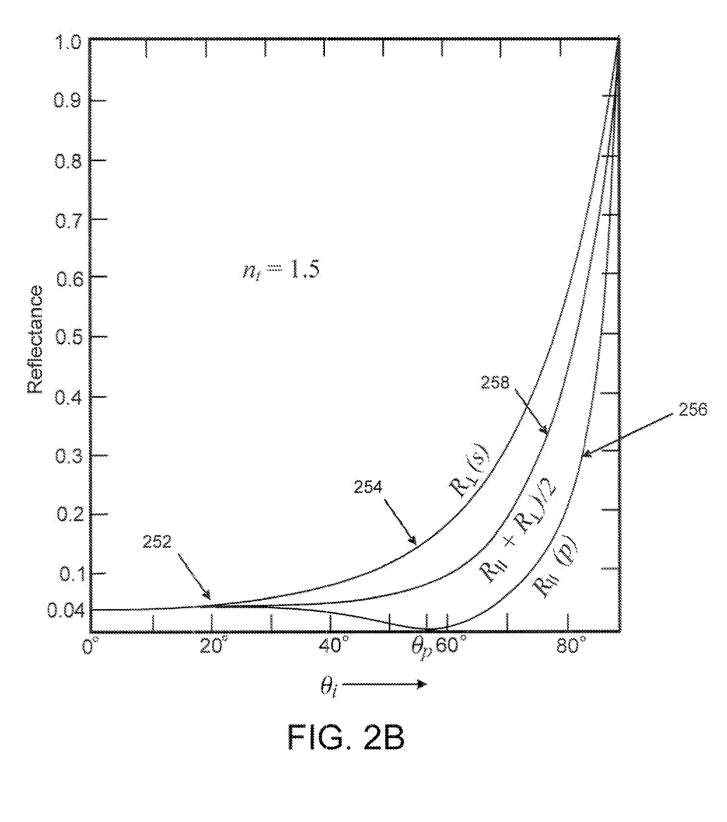

FIG. 3 is a schematic perspective view of a retardation film.

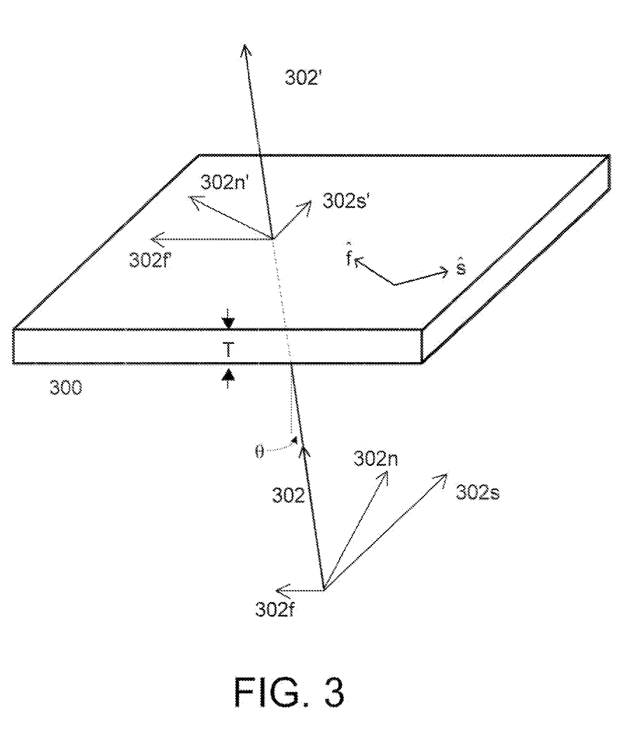

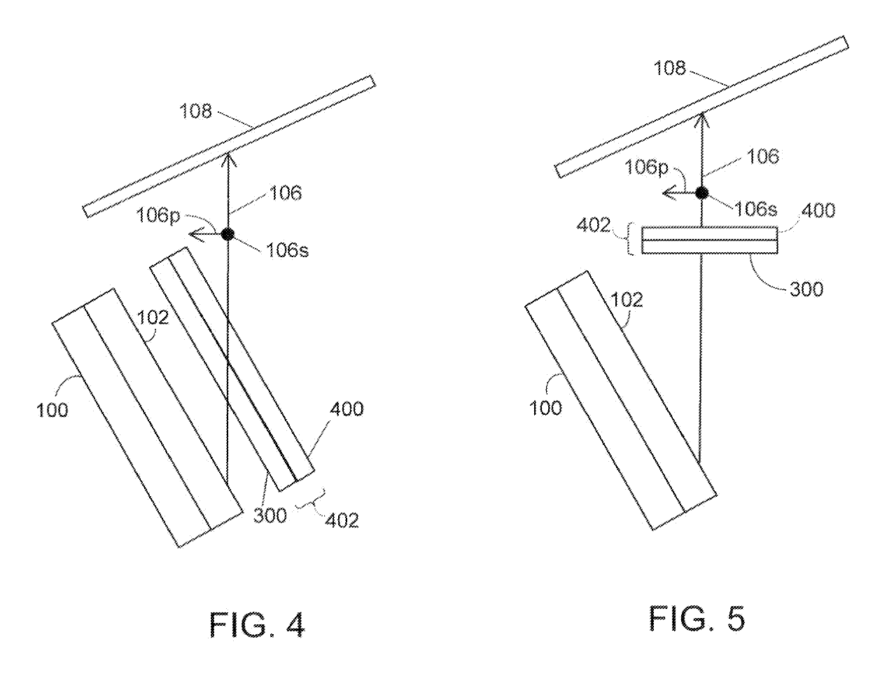

FIGS. 4 and 5 are schematic side views of components in a car.

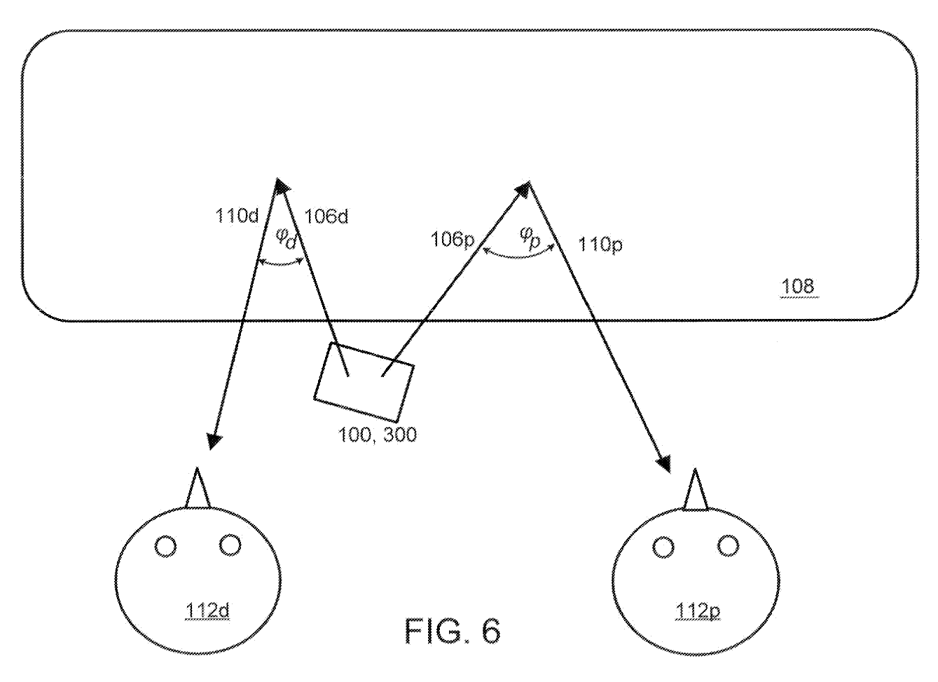

FIG. 6 is a schematic plan view of a driver and passenger in a car.

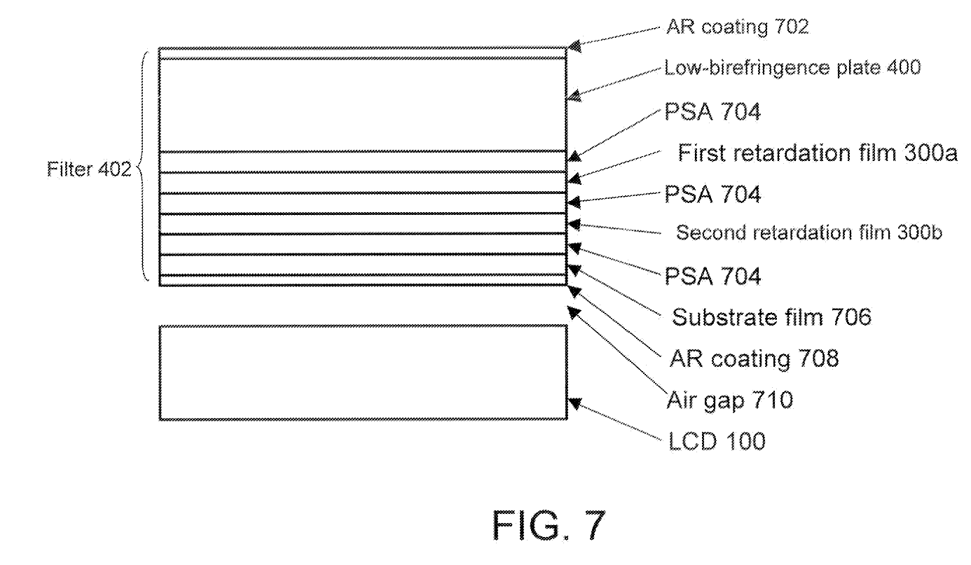

FIG. 7 is a schematic cross-section view of an optical filter.

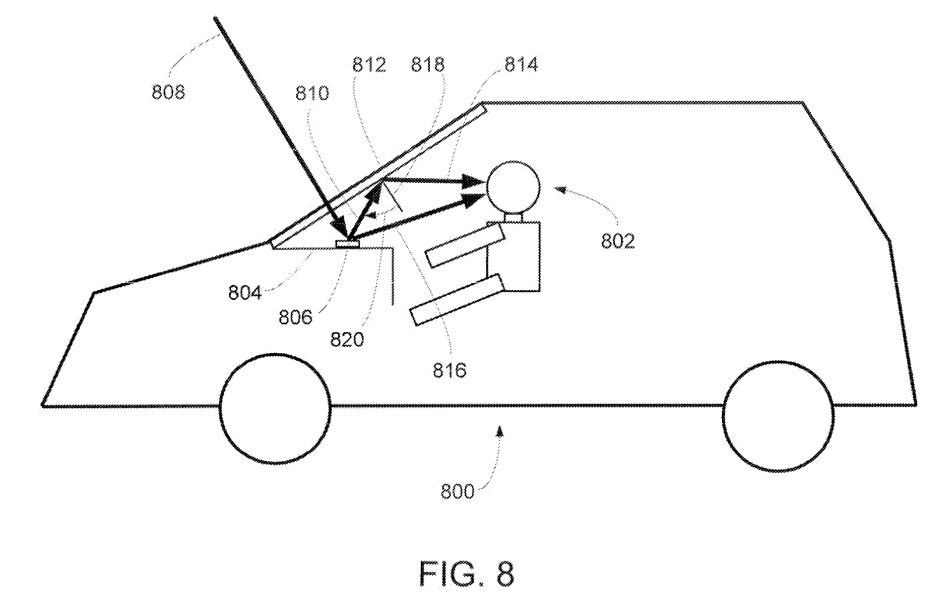

FIG. 8 is a schematic side view of a driver in a car.

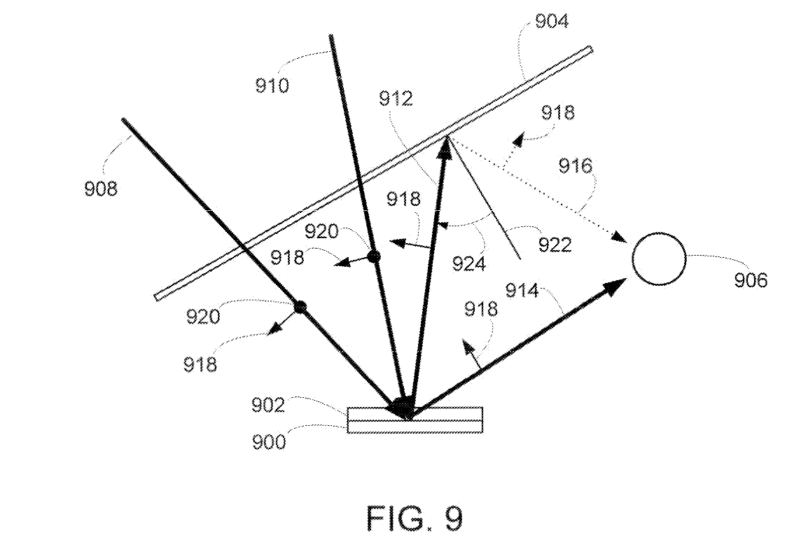

FIG. 9 is a schematic side view of components in a car.

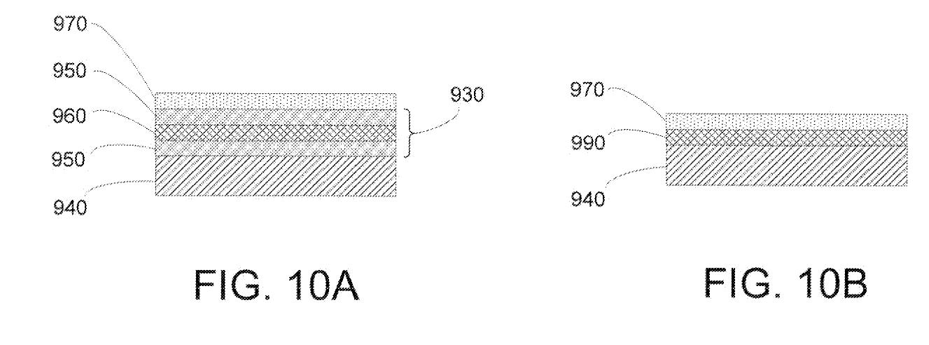

FIGS. 10A and 10B are schematic cross-section views of optical filters.

As shown in FIG. 1, an LCD screen consist of a backlight 100 and a light valve panel 102 located in the dashboard 12 of a car 10. Light from the backlight 100 passes through the panel 102 in multiple directions. Direct light 104 strikes and travels through the panel 102 at a low angle relative to a vector 103 normal to the panel 102 and travels directly from the backlight 100 to a driver 112. Such light is referred to as light having a low angle of incidence. Indirect light 106 travels through the panel 102 at a high angle relative to the normal vector 103 of panel 102 and is reflected by windshield 108. Such light is referred to as light having a high angle of incidence. Depending on the specific angles involved, reflected light 110 may be visible to the driver 112, causing the driver to perceive a reflection of the panel 102 in the windshield 108. In some cases, this reflection is undesirable. Alternatively, in some cases, for example, a heads-up display, the reflected light 110 is intended to be visible to the driver and the direct light 104 is not.

The amount of indirect light 106 that is reflected by the windshield 108 to produce reflected light 110 depends, among other things, on the polarization of the indirect light 106. As shown in FIG. 2A, light can be characterized as including perpendicular polarization components referred to as the s-polarized and p-polarized components. These represent components of an electric field vector oscillating, or vibrating, in the corresponding direction. Light having only one component (that is, the other component has a magnitude of zero) is sometimes referred to by that component, e.g., “s-polarized light.” Consider a plane 200 perpendicular to a reflective surface 202, such that vectors 204 and 206 represent the direction of travel of incident and reflected light and both rays of light are contained within the plane 200. The s-polarized component 204s of the incident light 204 has an electric field vector vibrating perpendicular to the plane 200 (in and out of the page in FIG. 2A), and the p-polarized component 204p has an electric field vector vibrating in the plane 200. Both components are perpendicular to the direction of travel of incident light 204.

If reflective surface 202 is a smooth surface such as glass, the s-polarized component 204s of incident light 204 has an electric field vector vibrating component 204p, which tends to be transmitted more at certain angles rather than reflected. The amount of reflection for each component depends on the angle of incidence θ₁, As shown in FIG. 2B, for a low angle of incidence, only a small part of both the s-polarized and the p-polarized components will be reflected, while for a high angle of incidence, nearly all of both components is reflected. In between, however, the components behave differently. At a point 252 on the graph, corresponding to an incident angle of about 20°, the reflectance of the s-polarized component (line 254) begins to substantially increase, while the reflectance of the p-polarized component (line 256) begins to substantially decrease. The reflectance of the p-polarized component reaches a minimum (no reflectance) at an angle θₚ before beginning to increase. The value of θₚ depends on the index of refraction of the material of the reflective surface. The index of refraction for most materials varies slightly with the wavelength of the incident light. The vertical axis of the graph is based on an index of refraction nᵢ equal to 1.5. For other indices of refraction, the vertical axis of the graph would be different. The average reflectance (line 258) of the two components, equivalent to light having equal s-polarized and p-polarized components (or natural, unpolarized light), remains low until about θₚ and then begins to increase, such that all three lines approach complete reflectance as the angle of incidence approaches 90°.

Returning to FIG. 1, one way to decrease the brightness of reflected light 110 is to make sure that the indirect light 106 has a small s-polarized component and large p-polarized component, relative to the windshield 108, so that most of the indirect light 106 incident on the windshield 108 will be transmitted. As shown in FIG. 3, a retarding film 300 (also known as a polarization rotator) reorients the polarization of light passing through it. Commercially available retarding films include the OptiGrafix™ retarder films available from Grafix Plastics, Cleveland, Ohio. A retarding film has two optical axes, a fast axis \hat{f} and a slow axis ŝ (in FIG. 3, \hat{f} and ŝ are orthogonal to each other, in the plane of the retarding film 300, rotated 45° from the edges of the film). The rotation of the film describes rotation of the film about a normal vector through its center, and is measured by the angle between the fast axis and some external reference, such as the edge of the film. Depending on the orientation of the film, the speed of light passing through the film will be different in the two directions. The speed of incident light vibrating along the fast axis \hat{f} will be faster than the light vibrating along the slow axis ŝ. As a result, the polarization of linearly polarized light can be rotated.

For example, in FIG. 3, incident light 302 has a relatively larger component 302s, and a relatively smaller component 302f, resulting in a net polarization 302n. Retarding film 300 effectively rotates the polarization of incident light 302 so that exiting light 302′ has a relatively smaller component 302s′ and a relatively larger component 302f′, resulting in a net polarization 302n′ at a substantially different angle than the original net polarization 302n.

The effect of the retarding film depends on its orientation relative to the polarization of the incoming light, its thickness T, and the angle of incidence θ. The amount by which each component is shortened or lengthened depends on how much of the retarding film material the light passes through. Light passing through the film at incident angles other than perpendicular passes through a greater amount of material, increasing its effect. In the case of a dashboard-mounted LCD panel 102, the light from the LCD has a known polarization and passes through the panel 102 and strikes the windshield 108 at known angles. As shown in FIG. 4, a thickness of retarding film 300 can be selected and the film positioned between the panel 102 and the windshield 108 such that the indirect light 106 will have a relatively larger p-polarized component 106p and smaller s-polarized component 106s and thereby minimize its reflection by the windshield 108.

In the example of FIG. 4, the retarding film 300 is laminated onto a low-birefringence plate 400 to form a filter 402. Birefringence is the property of a material where there are different indices of refraction depending on the direction of the light passing through the material. Retardation films have high birefringence. A low-birefringence plate is one in which the index of refraction of light is nearly the same for all directions and is therefore the same for both orthogonal components of polarization, and is used in this example to reduce any effect the plate 400 may have on the polarization beyond the effect of the retarding film 300. Attaching the retarding film 300 to the plate 400 assures that the retarding film 300 is positioned at the proper incident angles relative to the light 106 from the LCD backlight 100 and LCD panel 102 and at the proper rotational angle relative to the horizontal and vertical axes of the LCD panel. The birefringence plate 400 also protects the retarding film 300 from damage, separating it from the environment. Commercially available low-birefringence plates include the Clarex® brand made by Nitto Jushi Kogyo, Tokyo, Japan.

With this arrangement, a retarding film configured to assure that light passing through at a high angle is p-polarized relative to the windshield 108 can have the beneficial side effect of increasing the brightness of the LCD when directly viewed by a driver wearing polarized sunglasses. Polarized sunglasses are typically designed to block s-polarized light (since sunlight reflected off a horizontal surface, such as the ground or water, will be s-polarized relative to that surface). Since light from small and medium size LCD screens is typically polarized at a 45-degree angle relative to horizontal, half of the energy of such light is blocked by polarized sunglasses, decreasing its apparent brightness. A retarding film configured to rotate the light to have a large p-polarized component relative to the windshield 108 can also be arranged to rotate the direct light 104 to have a large p-polarized component relative to the driver's sunglasses.

In some examples, as shown in FIG. 5, the filter 402, including the retarding film 300, is placed between the panel 102 and the windshield 108, but not in the driver's field of view. This can allow the filter 402 and the retarding film 300 to be reduced in size, as only a small aperture is necessary to intercept all of the light 106 shining from the LCD 100 to the windshield 108.

In some examples, it is desirable to reduce the reflection of the LCD screen for both the driver and the passenger, who may view the reflection in the windshield at different compound angles φ_{d} and φₚ, especially if the LCD screen is angled towards the driver, as shown in FIG. 6. Some indirect light 106d strikes the windshield 108 and is reflected to the driver at one angle φ_{d}, while other indirect light 106p strikes the windshield 108 at a different angle φₚ. An angle of polarization that reduces the intensity of the reflected light 110d seen by the driver 112d might increase the intensity of the reflected light 110p viewed by the passenger 112p. In such a case, the retarding film 300 may be configured to achieve a polarization that reduces the reflection for both driver and passenger, though typically not to as great an extent as could be achieved if it were optimized for only one seating position. Similarly, the actual position of the driver and passenger will vary with the height of each and the position of their seat. The retarding film may be configured to optimize the reduction in reflection for the greatest range of seating positions.

Retarding films are generally commercially available in a finite set of retardation values. As shown in FIG. 7, multiple layers of retarding film may be combined to achieve the retardation values needed to produce the desired adjustment to polarization. Layers of retarding film 300a and 300b are adhered to each other, to the low-birefringence plate 400, and to an underlying substrate film 706 with a pressure-sensitive adhesive (PSA) 704 having a low birefringence, such as the optical adhesives available from Adhesives Research, Glen Rock, Pa. Anti-reflective coatings 702 and 708 are deposited or adhered to the top and bottom of filter 402 to help prevent reflections from the top and bottom surfaces. The assembled filter 402 is separated from the LCD panel 102 by an air gap 710. Different layers of retardation films may be positioned with their fast axes at different rotational angles to achieve a desired effect. The specific rotational angles chosen will depend on the angle of the windshield 108 relative to the LCD panel 102, the positions of the driver and passenger, and the polarization angle of the light generated by the LCD panel 102. In one case, it was found that a film with 165 nm of retardation at a wavelength of 560 nm and a film with 300 nm of retardation at a wavelength of 560 nm with their fast axes rotated 13 degrees counterclockwise from the vertical axis of the LCD produced the minimum amount of reflection from the windshield of a test vehicle for both the driver and passenger positions. In another case, two layers of 250 nm retardation film were each rotated at 90 degrees relative to each other with the back layer rotated 14 degrees counterclockwise from the screen horizontal and the front layer rotated 14 degrees counterclockwise from the screen vertical.

Another implementation concerns the reflection of light from the dashboard or objects on the dashboard. The reflection from an object on the dashboard may reflect from a window and form an image that is a distraction to drivers or passengers in the vehicle. By adding a polarizing layer between the object and the window, the polarization of the reflection from the object is converted from natural polarization to p-polarization. This reduces the reflection from the window and solves the problem of the distracting image. The object may reflect light primarily in all directions (diffuse reflection), or it may reflect light primarily in one direction with the angle of incidence equal to the angle of reflection (specular reflection).

In the example of FIG. 8, vehicle 800 has viewer 802, dashboard 804, surface 806, window 812, perpendicular 818, and incident angle 820. The bold arrows show light rays that form images. Outside light 808 passes through window 812, diffusely reflects from surface 806, and forms directly reflected light 816. Outside light 808 also diffusely reflects from surface 806, forms indirectly reflected light 810 which impinges on window 812 at incident angle 820 (measured from perpendicular 818, specularly reflects from window 812 and forms window reflected light 814. Both directly reflected light 816 and window reflected light 814 form images visible to viewer 802. Viewer 802 may be a driver or a passenger in vehicle 800. Window reflected light 814 forms an image of the reflected light from surface 806 in the window. The image of surface 806 is undesirable because it is superimposed on and interferes with the view's image of the surrounding environment.

In the example of FIG. 9, outside light 908 passes through window 904, passes through polarizing layer 902, impinges on surface 900, specularly reflects from surface 900, forms light 914, and forms an image visible to viewer 906. Another ray of outside light 910 (propagating in a different direction than the direction of outside light 908) passes through window 904, passes through polarizing layer 902, specularly reflects from surface 900, forms light 912, impinges on window 904 at incident angle 924 (measured from perpendicular 922), and specularly reflects from window 904 to form weak light 916 (as explained later) that does not form an image visible to viewer 906.

In FIG. 9, strong light rays are shown with bold lines and weak light rays are shown with dotted lines. There are two polarization states shown: p-polarization is shown by a short arrow perpendicular to the direction of light propagation. S-polarization is shown by a dot at the base of the p-polarization arrow signifying polarization in a direction perpendicular to the plane of the page. These polarization states are defined with respect to the reflection plane for window 904. The reflection plane is defined at the plane that includes both the incident light ray and the reflected light ray. In this example, the reflection plane for window 904 is the same as the reflection plane for surface 900. Outside light 908 and outside light 910 have natural polarization which is signified by having both a p-polarization arrow and an s-polarization dot.

In general, a polarizing layer has a polarization axis which is defined to be the axis in the same plane as the polarizing layer which is parallel to the direction of the polarizing layer that passes p-polarized light. In FIG. 9, polarizing layer 902 is rotated so that the polarization axis is in the same plane as the p-polarization arrow. With this orientation, polarizing layer 902 will transmit p-polarization and absorb s-polarization. In other words, the polarizing axis of polarizing layer 902 is substantially parallel to the viewing direction through the vehicle window.

Outside light 908 with natural polarization passes through polarizing layer 902, and becomes p-polarized light 914. With polarizing layer 902, the image of surface 900 is about 50% weaker in brightness than what it would be without polarizing layer 902.

Outside light 910 with natural polarization passes through polarizing layer 902, and becomes p-polarized light 912. As shown in FIG. 2B, the reflection of p-polarized light 916 from window 904 is at an intensity less than or equal to approximately 4% for incident angles less than roughly 70 degrees. Incident angles near 60 degrees are typical for the dashboard and front windshield geometries of many automobiles. The weak light 916 forms an image that is much reduced in brightness relative to the image that forms without polarizing layer 902.

In the example of FIG. 10A, polarizing layer 930 covers surface 940. Polarizing layer 930 includes protective layers 950 and stretched, dyed plastic layer 960. Protective layers 950 may be made of cellulose triacetate. Stretched, dyed plastic layer 960 may be made of polyvinyl acetate. Optional antireflection coating 970 may be added to reduce the reflection from the top of layer 930.

In the example of FIG. 10B, polarizing layer 990 covers surface 940. Polarizing layer 990 is a polarizing coating. The polarizing coating may be a liquid crystal material applied with a wet roller process. Optional antireflection coating 970 may be added to reduce the reflection from the top of layer 990.

In FIGS. 10A and 10B, the polarizing layer forms an optical filter that transmits one state of polarization and absorbs another state of polarization. Polarizing layer 930 or 990 may be attached to surface 940 by laminating to surface 940. Alternatively, polarizing layer 930 or 990 may be attached to surface 940 by pressure sensitive adhesive, UV-cure adhesive, or other attachment methods. Polarizing layer 930 or 990 may be placed in front of surface 940 without making an attachment. Surface 940 may be the dashboard itself, or may be a design feature on the dashboard. Design features are surfaces that have distinctive colorings or textures that highlight specific areas for ornamentation purposes such as a speaker bezel or a logo.

The vehicle may be an automobile, airplane, ship, or other vehicle that has a window. Any transparent or translucent surface may be considered a window. Windows may include windshields, and sunroofs. The windows may be located at the front, rear, sides, or other areas of the vehicle. In the case of an automobile, the front window is generally located close to and above the dashboard and the rear window is generally located close to and above the rear package shelf. The design feature may be on the dashboard, on the rear package shelf, or in another area of the vehicle.

Other implementations are within the scope of the claims. For example, the retarding film may be included in the LCD screen as part of the manufacturing process. A display based on liquid crystal on silicon (LCOS) or other technology could be used.

What is claimed is:

1. An apparatus comprising
an object having a surface that is positioned proximate to a window such that an image of the surface is reflected from the window in at least some lighting environments, and
a polarizing layer positioned between the surface and the window, the polarizing layer having a polarizing axis that is positioned to reduce visibility of the image reflected from the window.

2. The apparatus of claim 1 in which the window is a vehicle windshield.

3. The apparatus of claim 1 also comprising an antireflection layer.

4. The apparatus of claim 1 in which the polarizing layer comprises stretched and dyed plastic film.

5. The apparatus of claim 1 in which the polarizing layer comprises a polarizing coating.

6. The apparatus of claim 1 in which the polarizing axis is substantially parallel to a viewing direction through the window.

7. The apparatus of claim 1 in which the surface has a primarily diffuse reflection.

8. The apparatus of claim 1 in which the surface has a primarily specular reflection.

9. The apparatus of claim 1 in which the object is a design feature on a dashboard.

10. The apparatus of claim 1 in which the object is a speaker bezel.

11. The apparatus of claim 1 in which the object is a design feature on a rear package shelf.

12. The apparatus of claim 1 in which the polarizing layer is affixed to the surface.

13. A method comprising
decreasing a reflection of light from a surface, the light reflecting from a vehicle window, by placing a polarizing layer between the surface and the vehicle window, the polarizing layer being configured to absorb a polarization state of the light source.

14. The method of claim 13 in which the polarization state is substantially s-polarization for the reflection from the vehicle window.

15. The method of claim 13 further comprising affixing the polarizing layer to the surface.
